(19) United States
(12) Patent Application Publication
(10) Pub. No.: US 2014/0222989 A1
(43) Pub. Date: Aug. 7, 2014

(54) MANAGEMENT OF DEVICE MANAGEMENT UNITS

(71) Applicants: Shun Tanaka, West New York, NJ (US); Jim Vopni, Kitchener, CA (US)

(72) Inventors: Shun Tanaka, West New York, NJ (US); Jim Vopni, Kitchener, CA (US)

(73) Assignee: RICOH COMPANY, LTD., Tokyo (JP)

(21) Appl. No.: 13/758,103

(22) Filed: Feb. 4, 2013

(51) Int. Cl. H04L 12/24

(52) U.S. Cl. CPC H04L 41/20
USPC 709/224

(57) ABSTRACT

Systems, apparatuses and methods are provided for managing information technology devices in an information technology environment in which at least some of the devices are connected to a network and one or more management units are configured to manage such devices, wherein management of said one or more management units is facilitated by a core management unit.

### TECHNICAL FIELD

This disclosure relates to tools (such as systems, apparatuses, methodologies, computer program products, etc.) for managing information technology devices, and more particularly, such tools for managing device management units in a network.

### BACKGROUND

In the current information age, information technology (IT) assets (e.g., hardware, software, database, etc.) are extensively used in enterprises and other organizations in order to facilitate processing of documents and data and to allow users to access other functionalities and devices (such as computers, printers, scanners, multi-function devices (MFDs) and other network-connected or standalone devices, etc). However, while there have been many technical advances, IT systems are not yet fully automated and capable of self-maintenance, without human intervention. Thus, in each IT system, one or more IT administrators typically monitor and manage the devices in the system.

Device management tools (such as application software, etc.) are available to enable the administrators to track, monitor and otherwise manage the devices from remotely. For example, FIG. 1 illustrates a system 100 wherein management apparatus (e.g., device management software installed on a computer) 101 is connected to the network 102 and is configured to monitor and manage devices 103-1 through 103-N on the network 102. For example, the management apparatus 101 may be a server and the devices 103-1 through 103-N may be configured as clients of the device management service provided by the management apparatus 101. Such a server may periodically communicate with each client to check the status of the client, and when necessary, generate alert notifications to a specified administrator notification address.

However, the number of networked devices that must be managed is generally increasing and the typical IT administrator is required to oversee a growing number of IT assets. Since management tools, such as the management apparatus 101 illustrated in FIG. 1, are being used to manage a growing number of devices, the tools themselves need servicing (such as maintenance and update) evermore frequently. On the other hand, in the system shown in FIG. 1, servicing of the management apparatus 101 is preferably scheduled at an off-time, when network traffic and device usage is at a minimum. In some instances, such off-time rarely occurs. On the other hand, there are circumstances where servicing must be performed with little or no scheduling, given the circumstances. In any event, in the system shown in FIG. 1, when the management apparatus 101 is off-line while being serviced, the devices 103-1 through 103-N are not managed, and the longer the apparatus 101 is off-line, the more likely a catastrophic event is to occur in the system 100.

There exists a need for an improved system for managing IT devices.

### SUMMARY

Various tools (for example, a system, an apparatus, application software, etc.) can be provided to help an information technology (IT) administrator with management of IT assets in an IT system.

In an aspect of this disclosure, a core management unit monitors one or more device management units that manage devices in a network system. The core management unit registers, for each particular device management unit amongst the one or more device management units, a network address and authentication information specific to the particular device management unit and obtained in an installation process installing the particular device management unit on a corresponding host computer.

In another aspect, when a device management unit is uninstalled from the corresponding host computer, a core management unit obtains setting information of the particular device management unit and device information maintained by the particular device management unit from the particular device management unit, and stores the obtained setting information and device information in a storage unit. The stored setting information is employed to reinstall the particular device management unit on another host computer, without having a user specify settings for reinstalling the particular device management unit on said another host computer.

In another aspect, a core management unit registers a particular device management unit in a device management registry, and when the particular device management unit is uninstalled from a host computer, the core management unit unregisters the particular device management unit from the device management registry, but continues to store the setting information and the device information obtained from the particular device management unit. When the particular device management unit is reinstalled on another host computer, the core management unit causes the stored device information to be uploaded to the particular device management unit reinstalled on said another host computer.

In another aspect, a core management unit maintains, for each specific device amongst various network devices in the system, device management data that includes device assignment data associating the specific device with a specific device management unit assigned to manage the specific device. The core management unit modifies the device assignment data of the specific device to reassign management of the specific device from the specific device management unit to another device management unit.

In another aspect, when a particular device management unit is inactive or unavailable for at least a predetermined period of time, the core management unit automatically modifies the device management data of each particular device amongst one or more particular devices assigned to be managed by the particular device management unit, to associate the particular device with another device management unit for managing said particular device.

In another aspect, a core management part assigns to a particular device management unit a management unit name, and the management unit name is registered in association with the particular device management unit in a registry of the device management units. When the particular device management unit is reinstalled on said another host computer, the core management unit automatically registers the particular device management unit in the registry once again using the same management unit name.

In another aspect, the core management unit communicates with a license management device external to the core management unit and registers the particular device management unit in association with a network address of the core management unit, with the license management device.

### BRIEF DESCRIPTION OF THE DRAWINGS

The aforementioned and other aspects, features and advantages can be more readily understood from the following detailed description with reference to the accompanying drawings wherein:

FIG. 1 shows a block diagram of a conventional data management system;

FIG. 2A shows a block diagram of a system for managing a plurality of network-connected devices, according to an exemplary embodiment;

FIG. 2B shows a block diagram of a system for managing a plurality of network-connected devices, according to another exemplary embodiment;

FIG. 2C shows a block diagram of a system for managing a plurality of network-connected devices, according to another exemplary embodiment;

FIG. 3 shows a block diagram of a system for managing a plurality of network-connected devices, according to another exemplary embodiment;

FIG. 4 shows a block diagram of a system for managing a plurality of network-connected devices, according to another exemplary embodiment;

FIG. 5A shows a sample device data stored by a device management unit, according to an exemplary embodiment;

FIGS. 5B and 5C show sample data stored by a core management unit, according to an exemplary embodiment;

FIG. 6A shows a block diagram of a configuration of a device management unit and/or a core management unit, according to an exemplary embodiment;

FIG. 6B shows a block diagram of a configuration of a terminal, according to an exemplary embodiment;

FIG. 6C shows a block diagram of a configuration of a multi-function device, according to an exemplary embodiment;

FIG. 7 shows a sample screenshot of a user interface displayed to the user, according to an exemplary embodiment;

FIG. 8 shows a sample screenshot of a user interface displayed to the user, according to an exemplary embodiment;

FIG. 9A shows a sample screenshot of a user interface displayed to the user, according to an exemplary embodiment;

FIG. 9B shows a sample screenshot of a user interface displayed to the user, according to an exemplary embodiment;

FIG. 10A shows sample data stored by a device management unit and/or a core management unit, according to an exemplary embodiment;

FIG. 10B shows sample data stored by a device management unit and/or a core management unit, according to an exemplary embodiment;

FIG. 10C shows sample data stored by a device management unit and/or a core management unit, according to an exemplary embodiment;

FIG. 11A shows a sample screenshot of a user interface displayed to the user, according to an exemplary embodiment;

FIG. 11B shows a flowchart of a method of reinstalling a device management unit, according to an exemplary embodiment;

FIG. 12A shows a flowchart of a method of installing a device management unit, according to an exemplary embodiment;

FIG. 12B shows a flowchart of a method of reinstalling a device management unit, according to an exemplary embodiment;

FIG. 13 shows a flowchart of a method of uninstalling a device management unit, according to an exemplary embodiment;

FIG. 14 shows a flowchart of a method of reassigning devices to a device management unit, according to an exemplary embodiment; and

FIG. 15 shows a flowchart of a method of activating a device management unit, according to an exemplary embodiment.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

Referring now to the drawings, wherein like reference numerals designate identical or corresponding parts throughout the several views, there is described tools (systems, apparatuses, methodologies, computer program products, etc.) for managing information technology devices, such as computers, printers, scanners, multi-function devices, and other network-connected, or standalone, devices (such as a projector unit, a video conference device, a telephone conference device, a shredding device, a stamp device, etc.), and for managing one or more networks to which a plurality of such information technology devices are connected.

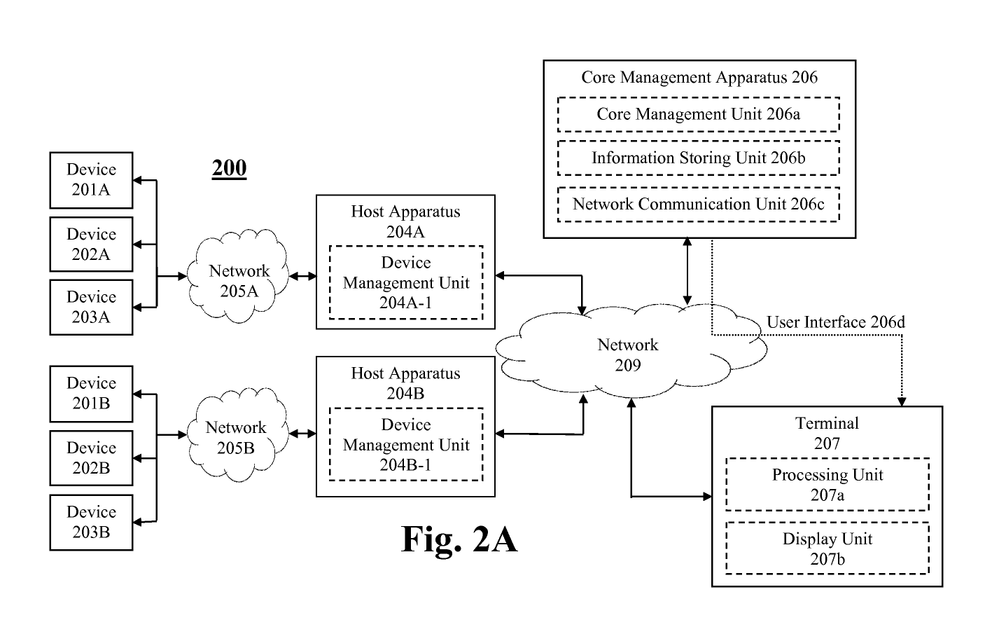

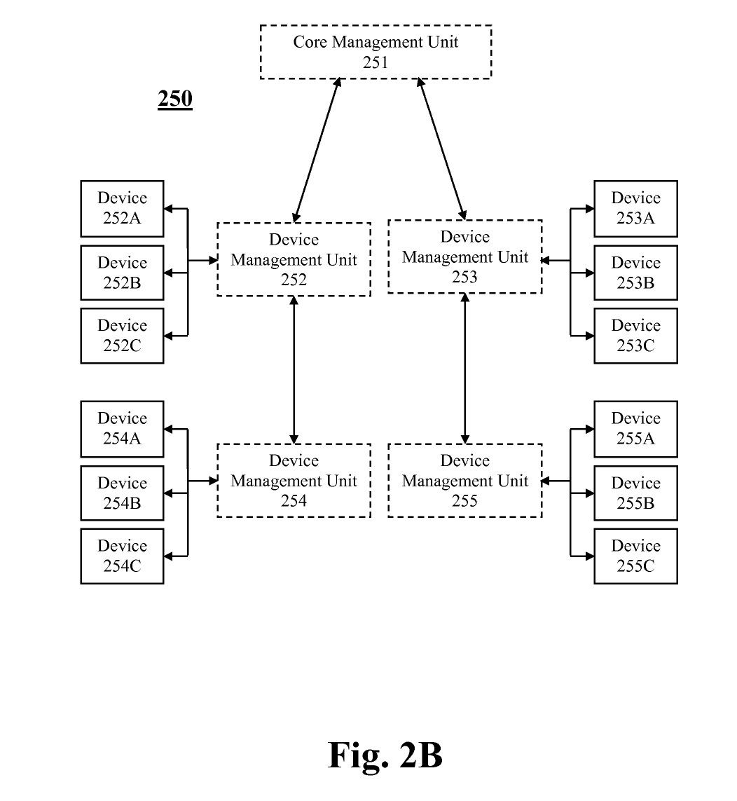

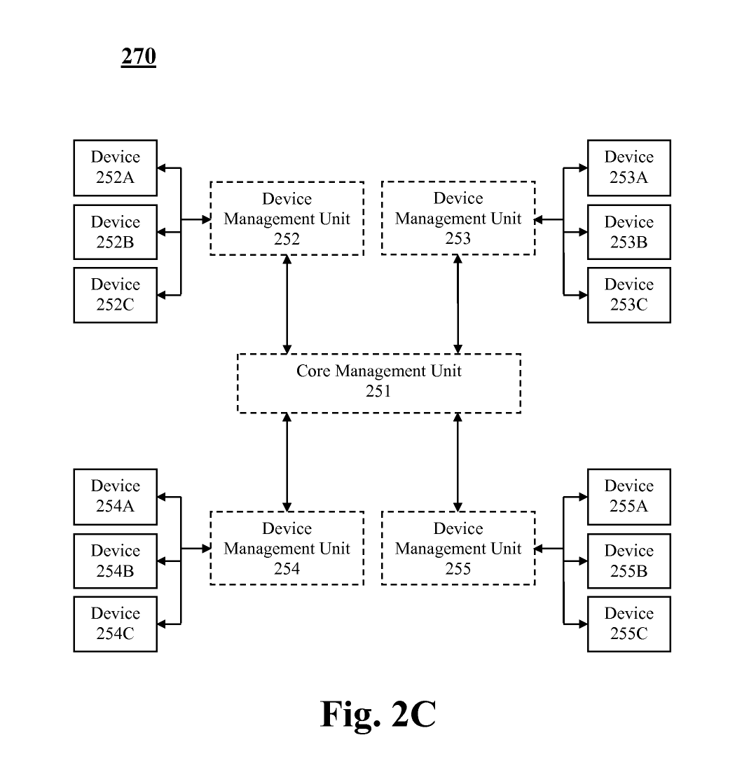

For example, FIG. 2A shows schematically a system 200 for managing a plurality of devices connected to a network, according to an exemplary embodiment. The system 200 includes devices (i.e. network-connected devices) 201A-203A and a device management (DM) unit 204A-1 installed on a host apparatus 240A, all of which are interconnected by a network 205A (“Network A”); devices 201B-203B and a device management unit 204B-1 installed on a host apparatus 240B, all of which are interconnected by a network 205B (“Network B”); a core management apparatus 206 and a terminal 207, both of which are interconnected by a network 209 (“Network C”). The host apparatuses 204A and 204B are also connected to the network 209.

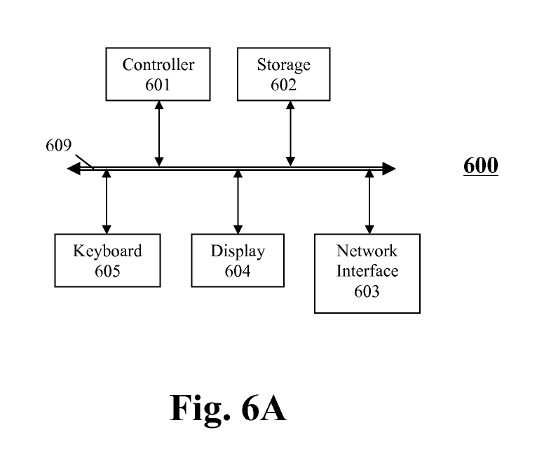

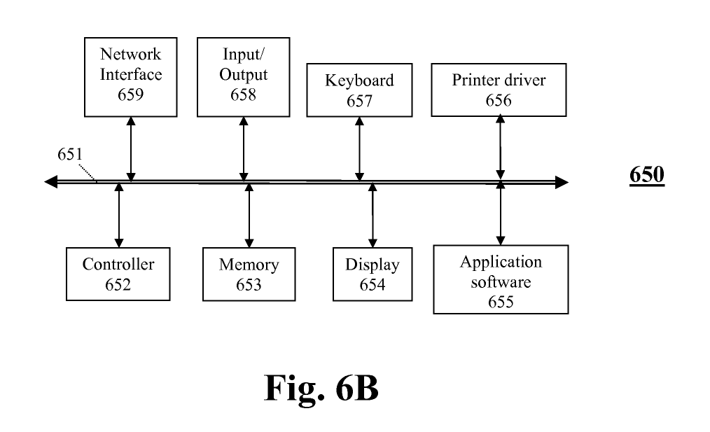

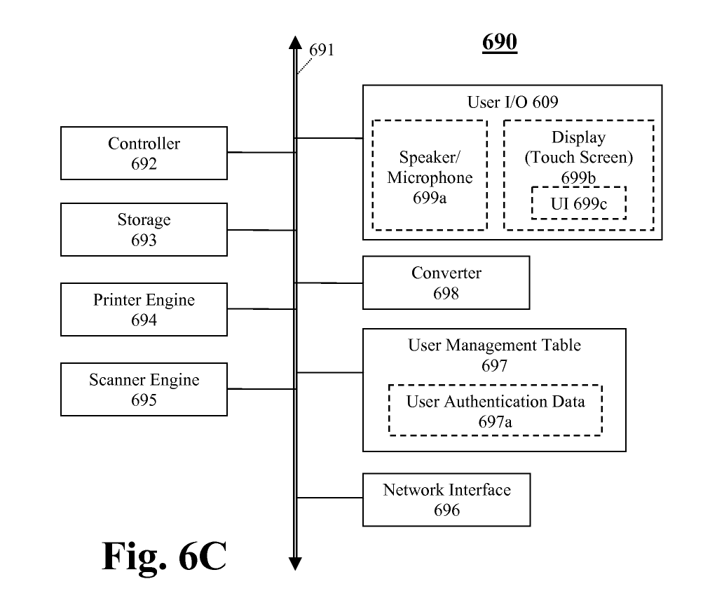

The devices 201A-203A and 201B-203B may include, for example, a printer, a scanner, a terminal and/or a multi-function device (MFD). While this example of this disclosure simply refers to devices 201A-203A and 201B-203B in the interest of brevity, the aspects of this disclosure are applicable to a network environment having an arbitrary number of devices. An exemplary configuration a network device as an MFD is described infra with reference to FIG. 6C.

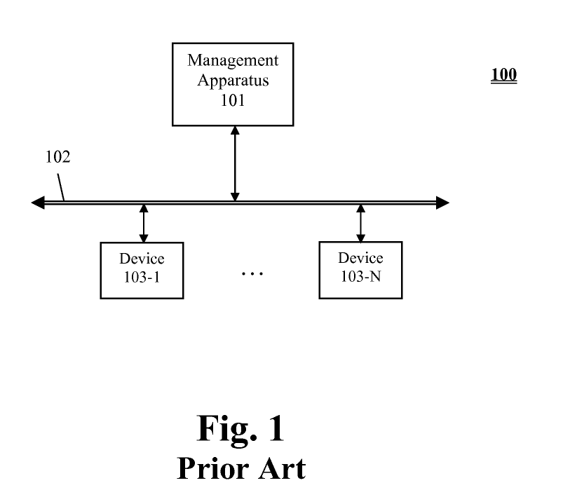

The device management units 204A-1 and 204B-1, each of which are implemented on the corresponding host apparatus, are configured to manage and collect device data from the devices in the system 200. In particular, each of the device management units 204A-1 and 204B-1 may be responsible for managing and collecting data from a subset of the devices in the system 200. For example, as shown in FIG. 1, the device management unit 204A-1 manages and collects device data from the devices 201A-203A, and the device management unit 204B-1 manages and collects device data from the devices 201B-203B. The device data collected by the device management units 204A-1 and 204B-1 may respectively be stored in internal storage units therein, external storage units connected thereto, or storage units accessible via the networks 205A and 205B.

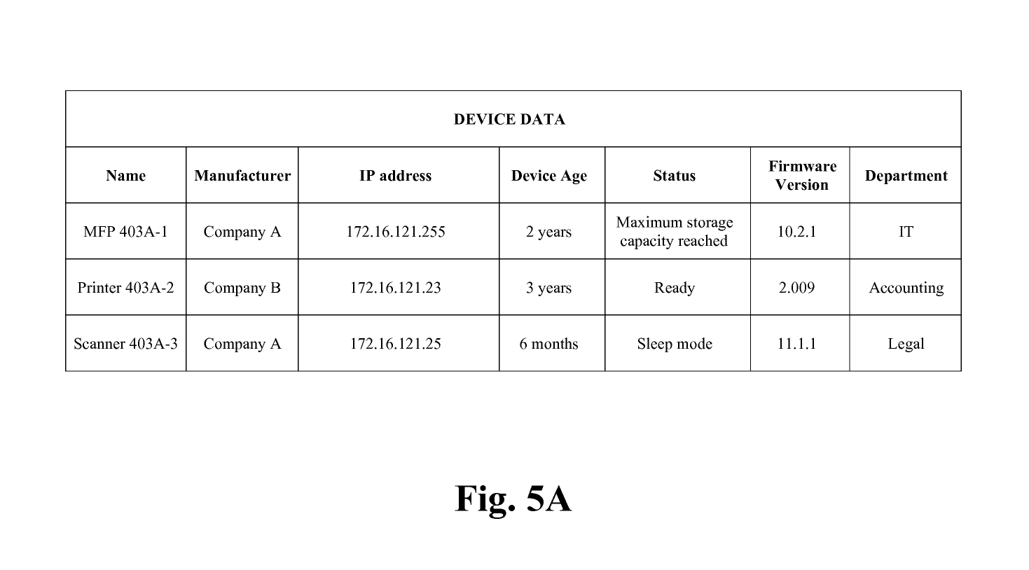

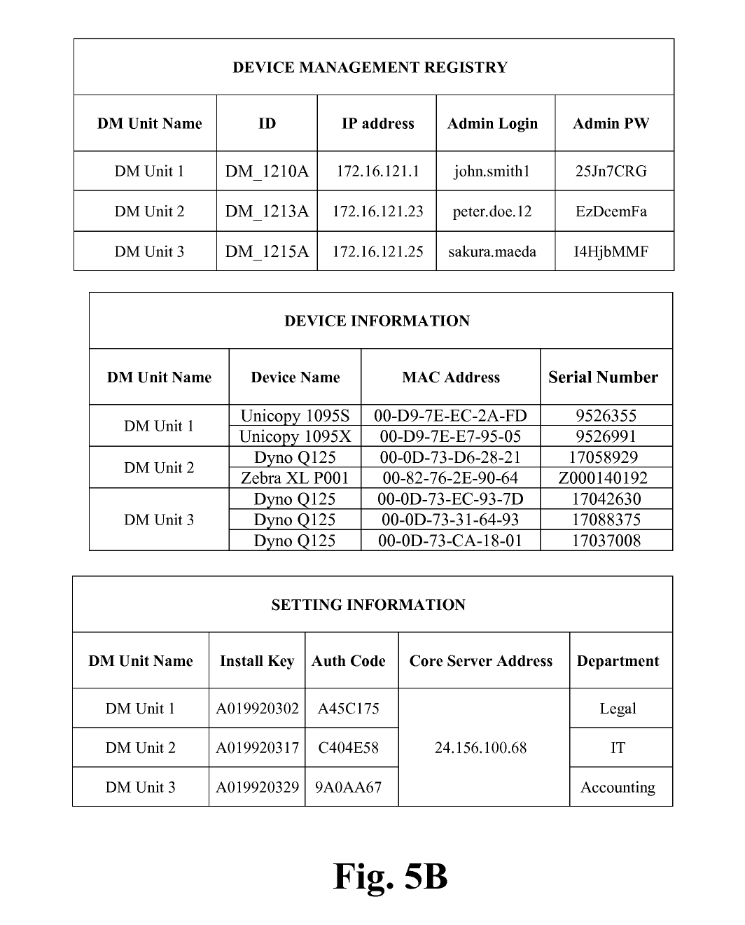

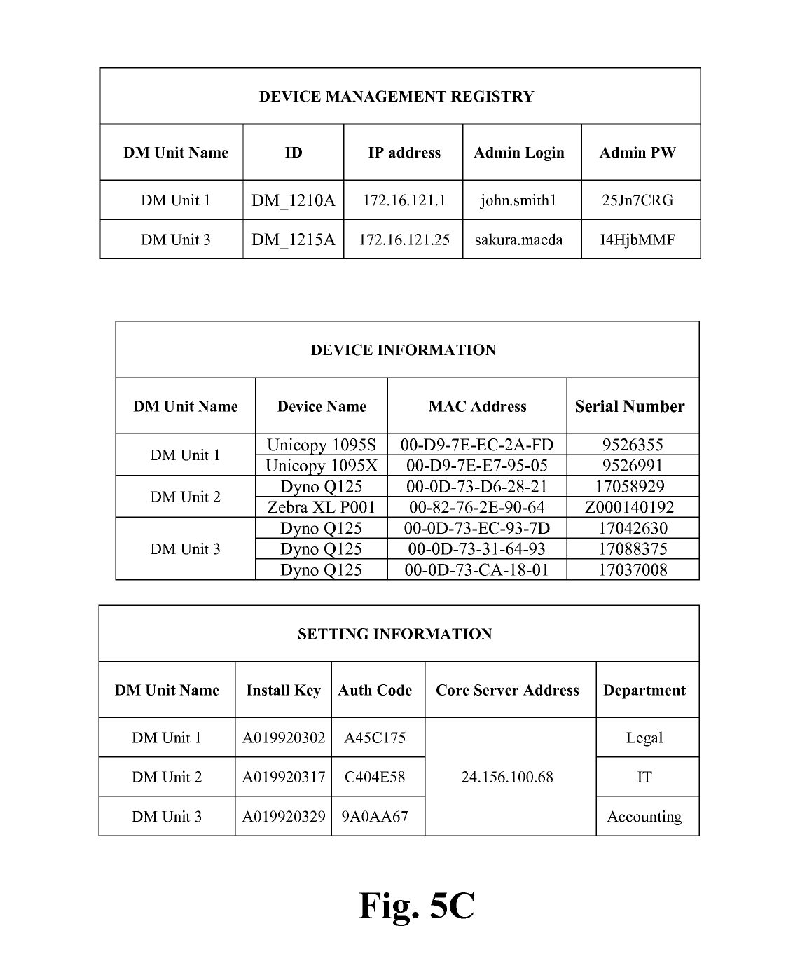

An example of device data collected by the device management units 204A-1 and 204B-1 from the devices 201A-203A and 201B-203B is illustrated in FIG. 5. As seen in FIG. 5, the device data for each device may include a variety of attributes such as name, manufacturer, IP address, device age, status, firmware version and department. The information depicted in FIG. 5 is merely exemplary, and other network devices, device status information, device properties, device configuration information, and so forth, may be included in the device data collected by the data management units. As non-limiting examples, the device data may include one or more of the following for a given network device: device manufacturer; device model; device serial number; device type (printer, scanner, terminal, etc.); device location (physical address, geographic address, network address, IP address, MAC address, etc.); output technology (e.g., laser, inkjet solid ink, thermal, other technology, etc.); device location type (e.g., production/copy center, in a specific workgroup area, etc.); scope (e.g., within the scope of administrative responsibility of a particular IT administrator, outside the scope of administrative responsibility of particular IT administrator, etc.); connection type (e.g., network connected, workstation/local connected, non-connected, etc.); device age (e.g., <1 year, 1-2 years, 2-3 years, 3-4 years, 4-5 years, >5 years, etc.); functions (e.g., copy, fax, print, scan, copy/scan, copy/fax, copy/print, print/fax, print/scan, copy/print/fax, copy/print/scan, copy/print/fax/scan, etc.); firmware version (e.g., major version, minor version, etc.); installed applications (e.g., application name, major version, etc.); organization (e.g., different groups, sub-groups, levels, departments, divisions and so forth within a larger enterprise or institutional entity, such as management group, sales group, marketing group, research & development group, etc.); supply level (e.g., consumable types such as paper and toner>empty/low/ok, etc.); capability (e.g., color, economy color, monochrome only, color scan, duplex, A3, not A3, etc.); last status update (e.g., 10 minutes, 60 minutes, 6 hours, etc.); duplex usage (e.g., 2:1, 1:2, 2:2, Book Duplex, etc.); paper size usage (e.g., A3, A4, B4, etc.); pages per job (e.g., 1, 2, 6-10, etc.); pages per minute (PPM) range (e.g., 1-20 ppm, 41+ ppm, etc.); color technology (e.g., professional color, convenience color, etc.); audit results/analysis (e.g., devices which satisfied a particular audit or test, devices which did not satisfy a particular audit or test, etc.); and so forth.

The device data collected by the device management units 204A-1 and 204B-1 may also include error history information that includes a log of all errors occurring at the corresponding managed device, and usage history information indicating which users have the utilized the managed device and when such use has occurred. The usage history information may indicate, for example, a number of total impressions (e.g. pages) produced by a user, or a number of specific types of impressions (copy color, copy BW, print color, print BW, etc.) produced by a user.

The device management units 204A-1 and 204B-1 communicate with one or more of the plurality of network-connected devices to collect and obtain the various device data corresponding to each device. Many printers and other devices store data indicating their attributes or properties in a Management Information Base (MIB). The MIB may conform with the SNMP (Simple Network Management Protocol) protocol, and properties information can be obtained directly from the MIB through SNMP queries. In this way, the device management units 204A-1 and 204B-1 are configured to discover and/or poll the corresponding plurality of network devices to obtain the device data from the network devices.

The device management units 204A-1 and 204B-1 may obtain the device data (such as the name, status, configuration information, error history, usage history, etc.) from each network device by monitoring a network to which the device is connected (i.e. networks 205), and detecting and receiving one or more alert notifications or status updates transmitted to the network from any of the plurality of network-connected devices 201-203. For example, the device management units 204A-1 and 204B-1 may receive the status updates by repeatedly transmitting requests to the network-connected devices 201-203 via the networks 205, inquiring as to the status of each network device. In response, each network device may transmit status updates back to the corresponding device management unit, wherein each status update indicates the device name, status, configuration information, error history, usage history, whether an error exists or has occurred at the network device, etc. Alternatively, each network-connected device may automatically transmit status updates to the corresponding device management unit (without waiting for requests or queries from the device management unit), at regular intervals or whenever an error occurs at the network-connected device. The device management units 204A-1 and 204B-1 may include locally resident hardware and/or software agents installed locally on each of the devices 201-203, which are configured to transmit the status updates directly to the corresponding device management unit. The device data may be stored along with other data in one or more storage units external to the device management units 204A-1 and 204B-1, or alternatively, in one or more storage units resident in the device management units 204A-1 and 204B-1 and retrieved as needed.

Referring back to FIG. 2A, the networks 205A and 205B may, for example, each represent an intranet for a particular office of an enterprise, which has an enterprise network (e.g. network 209) connecting each of the intranets.

Although the networks 205A, 205B and 209 are illustrated as being separate networks, the system 200 is not limited to such configuration, and any of the networks shown in FIG. 2A may be combined and/or separated, and the system 200 may include any arbitrary number of networks.

Also, how the core management apparatus 206, host apparatuses 204 and terminal 207 are connected is not limited to the configuration shown in FIG. 2A. For example, a core management unit 251 may be connected to one or more device management units (e.g., 252-255 on corresponding host apparatuses) which are connected to one or more network devices and/or further device management units for managing other network devices, such as in system 250 shown in FIG. 2B, or, as another example, each device management unit (252-255) may report to the core management unit 251 but not to each other, such as in system 270 shown in FIG. 2C.

Each of the core management unit 251 and the device management units 252-255 may be implemented on a host computer, a network device (e.g. MFD), a terminal, or any other device including a processor and a non-transitory computer-readable storage medium.

For example, systemic changes to devices (e.g. changes to be made to all devices or all devices of the same type) may be configured via the core management unit (e.g. on a core management apparatus) by a super administrator who oversees the entire network environment, since the core management unit is connected to all the devices in the network environment, either directly or indirectly. On the other hand, the device management units only manage a subset of the devices in the network environment. Thus, a local administrator at a regional office of the enterprise may configure devices within the local network (e.g. devices 254A-254C via the device management unit 254). The configuration of the system 250 is not limited to the example illustrated in FIG. 2B, and may include any arbitrary number of device management units and network devices.

As shown in FIG. 2A, the core management apparatus 206 includes a core management unit 206a, an information storing unit 206b and a network communication unit 206c.

The core management unit 206a monitors the device management units 204A-1 and 204B-1 and registers for each particular device management unit of the device management units 204A-1 and 204B-1 a network address and authentication information specific to the particular device management. Such network address and authentication information is obtained during the installation process for installing the particular device management unit on a corresponding host computer.

When the particular device management unit is uninstalled from the corresponding host computer, setting information of the particular device management unit and device information maintained by the particular device management unit are obtained from the particular device management unit, received through the network communication unit 206c, and stored in the information storing unit 206b.

When the particular device management is to be reinstalled on another host computer, the setting information stored by the information storing unit 206b is communicated through the network communication unit 206c and employed to reinstall the particular device management unit on said another host computer. Thus, instead of the user reinstalling the particular device management unit having to specify settings for the particular device management unit, the setting information that the particular device management unit requires in order to function properly is automatically retrieved from the core management apparatus 206.

In another exemplary embodiment, the core management unit 206a communicates with the particular device management unit being installed

Thus, even if the device management unit is being installed for the first time, settings of the device management unit can automatically be configured user intervention.

In another exemplary embodiment, the core management unit 206a registers each device management unit in a device management registry which lists each of the device management units registered with the core management unit.

FIG. 5B shows sample tables including the information collected by the core management unit 206a and stored in the information storing unit 206b, according to an exemplary embodiment.

As shown in FIG. 5B, a device management registry is a list of device management units registered with the core management unit 206a. For example, the device management registry of FIG. 5B has three device management units listed along with the ID and IP address of each device management unit.

Further, the device information table of FIG. 5B lists the devices managed by each of the device management units, and the setting information table of FIG. 5B lists the setting information needed to configure each device management unit. Such setting information may include information retrieved by the core management unit 206a from the device management units, or information generated by the core management unit 206a upon the installation and registration of the device management units (e.g. based on the type, model, make, etc. of the device management unit).

The setting information stored by the core management unit is not limited to that shown in FIG. 5B, but may also include any other information regarding the corresponding device management unit, such as: manufacturer; model; serial number; unit type (server, printer, scanner, terminal, etc.); location (physical address, geographic address, network address, IP address, MAC address, etc.); location type (e.g., production/copy center, in a specific workgroup area, etc.); scope (e.g., within the scope of administrative responsibility of a particular IT administrator, outside the scope of administrative responsibility of particular IT administrator, etc.); connection type (e.g., network connected, workstation/local connected, non-connected, etc.); functions; firmware version (e.g., major version, minor version, etc.); installed applications (e.g., application name, major version, etc.); organization (e.g., different groups, sub-groups, levels, departments, divisions and so forth within a larger enterprise or institutional entity, such as management group, sales group, marketing group, research & development group, etc.); and so forth.

The tables shown in FIG. 5B are mere examples and each of the device management registry, the device information and the setting information may include any other variables and parameters.

Referring back to FIG. 2A, the core management unit 206a and/or the device management units 204A-1 and 204B-1 may be realized by a computer program product including a computer-usable, non-transient medium (such as a disk storage apparatus) having instructions tangibly embodied therein that are executed by a computer. Thus, it should be understood that the core management unit 206a and/or the device management units 204A-1 and 204B-1 may be executed on a computer (e.g. core management apparatus 206 and/or the host apparatuses 204 shown in FIG. 2A). While the core management unit 206a and/or the device management units 204A-1 and 204B-1 are shown as being external to the network devices, the core management unit 206a and/or the device management units 204A-1 and 204B-1 may in fact be executed on a client terminal and/or network-connected device.

The core management unit 206a and/or the device management units 204A-1 and 204B-1 may include a data store that can comprise one or more structural or functional parts that have or support a storage function. For example, the data store can be, or can be a component of, a source of electronic data, such as a document access apparatus, a backend server connected to a document access apparatus, an e-mail server, a file server, a multi-function peripheral device (MFP or MFD), a voice data server, an application server, a computer, a network apparatus, a terminal etc. It should be appreciated that the term “electronic document” or “electronic data”, as used herein, in its broadest sense, can comprise any data that a user may wish to access, retrieve, review, etc.

As an example, the core management unit 206a (or the core management apparatus 206) may be used by a super administrator who is in charge of managing an entire enterprise network which may include plural regional networks (e.g. Networks A and B). In contrast, each local administrator may be in charge of managing one of such plural regional networks via the device management units 204A-1 and 204B-1.

The information storing unit 206b stores information captured from the device management units 204A-1 and 204B-1. For example, as discussed above, setting information of the particular device management unit and device information maintained by the particular device management unit (which is obtained from the device management unit and received through the network communication unit 206c) are stored in the information storing unit 206b.

Further, when a particular device management unit is uninstalled from the corresponding host computer, thus making itself unavailable to the core management unit 206a, the information storing unit 206b continues to store the setting information of the particular device management unit and the device information that was captured from the particular device management unit. By doing so, when the particular device management unit is later reinstalled on the same or another host computer, the stored setting information of the particular device management unit can be utilized to reinstall the particular device management unit, and the device information of the particular device management unit can be uploaded to the particular device management unit upon reinstallation of the particular device management unit, thereby eliminating the need for the particular device management unit to re-collect the device information from the devices managed by the particular device management unit.

The network communication unit 206c allows the core management apparatus 206 to communicate through the network 209, such as with the device management units 204A-1 and 204B-1 and the terminal 207.

In another exemplary embodiment, the network communication unit 206c is also configured to communicate with any particular device amongst plural heterogeneous devices that may be included in the system 200 in a communication format native to the particular device. For example, in the system 200, the network communication unit 206c may be configured to communicate with each of the devices 201-203 (including any other device management units, terminals and/or other devices that may be connected to the network 209) in a communication format established by the respective manufacturers/vendors of such devices. The network communication unit 206c may determine an appropriate communication format native to the particular device by any of various known approaches. For example, the network communication unit 206c may refer to a database or table, maintained internally or by an outside source, to determine an appropriate communication format native to the device. As another example, the network communication unit 206c may access an Application Program Interface (API) of the particular device, in order to determine an appropriate communication format native to the device.

As discussed above, the network communication unit 206c also receives setting information and device information from the device management units, communicates such setting information to a corresponding host computer when a device management unit is being installed.

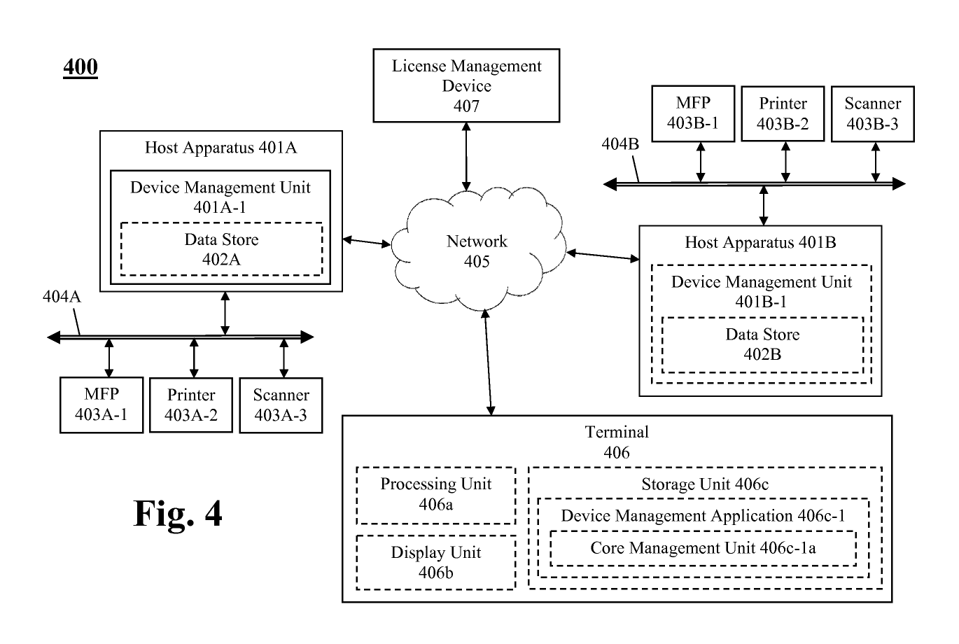

Further, the network communication unit 206c may also communicate with a license management device external to the core management apparatus to activate or deactivate a particular device management unit. Such activation and deactivation of device management units are further discussed infra with reference to FIG. 4.

As shown in FIG. 2A, the terminal 207 includes a processing unit 207a and a display unit 207b. For example, the core management unit 206a causes the processing unit 207a to execute a core management application, which causes the display unit 207b to display a user interface 206d. The user at the terminal 207 (e.g. an administrator of the network environment managed and monitored by the core management apparatus 206) can manage the plurality of device management units assigned to the core management apparatus 206, via the user interface 206d. The terminal 207 is further described infra with reference to FIG. 6B.

Each of the network connections 205 and 209 can include one or more connections via a secure intranet or extranet, a local area network (LAN), a wide area network (WAN) or any type of network such as an intranet, an extranet (for example, to provide controlled access to external users, for example through the Internet), the Internet, etc., or a combination thereof. Further, other communications links (such as a virtual private network, a wireless link, etc.) may be used as well for the networks 205 and 209. In addition, the networks 205 and 209 preferably use TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference. Although the devices 201-203 depicted in FIG. 2A are shown as being connected to one or more networks, the aspects of this disclosure may be applied to a system for managing a device that is not connected to a network but utilizes instead point-to-point communication, such as radio-frequency identification (RFID) technology. Such technology is well-known in the art and a description thereof is omitted in the interest of brevity.

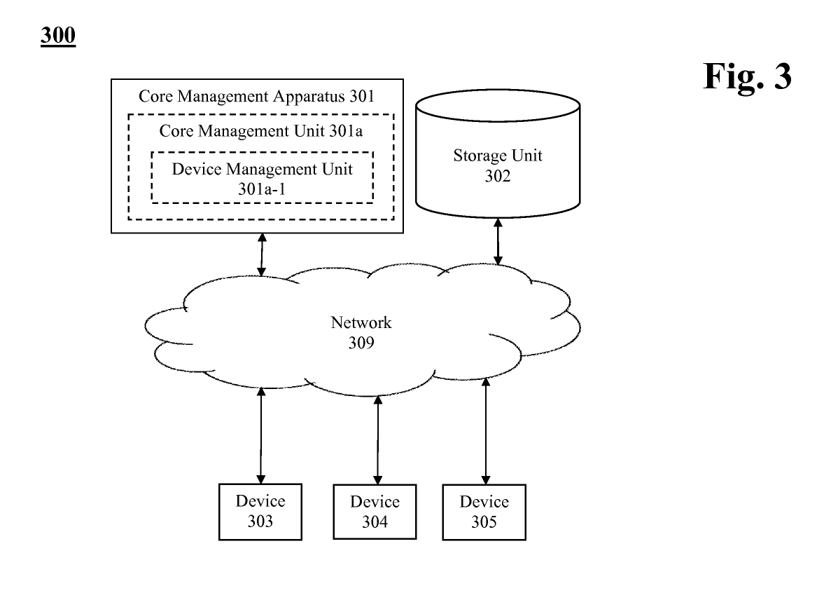

With reference to FIG. 3, a system for managing a plurality of network-connected devices, according to another exemplary embodiment, is described below.

The example of FIG. 3 illustrates a system 300 which includes a core management apparatus 301, a storage unit 302, network-connected devices 303-305, all of which are interconnected by a network 309. In the system 300, the core management apparatus 301 includes a core management unit 301a, which includes a device management 301a-1 (e.g. implemented as a single server). Although not shown in FIG. 3, the core management unit 301a may include therein a plurality of device management units for managing the network-connected devices 303-305 via the network 309.

In the example of FIG. 3, the storage unit 302 stores, for example, the device data collected by the device management unit 301a from the devices 303-305 and/or setting information and device information of the device management unit 301a collected by the core management unit 301. In addition, the device management registry described with reference to FIGS. 5B and 5C may also be stored in the storage unit 302. For example, the device management registry may be accessed by other devices in the network environment without having to go through the core management unit 301a.

In another exemplary embodiment, the storage unit 302 may be connected directly to the core management unit 301 or included within the core management unit 301. Although only one network (309) and three network devices (303-305) are shown in FIG. 3 in the interest of brevity, but the system 300 is not limited to such configuration. The core management unit 301 may be connected to any arbitrary number of devices via one or more networks.

Otherwise, operations of the elements of the system 300 are similar to those discussed in connection with the corresponding elements of the system 200 of FIG. 2A.

With reference to FIG. 4, a system for managing a plurality of network-connected devices, according to another exemplary embodiment, is described below.

The example of FIG. 4 illustrates a system 400 which includes a host apparatus 401A, an MFP 403A-1, a printer 403A-2 and a scanner 403A-3, all of which are interconnected by a network 404A (collectively “Network A”); a host apparatus 401B, an MFP 403B-1, a printer 403B-2 and a scanner 403B-3, all of which are interconnected by a network 404B (collectively “Network B”); and a terminal 406 which is connected to the device management units 401 and a license management device via a network 405. The host apparatuses 401A and 401B include device management units 401A-1 and 401B-1, respectively. Further, the device management units 401A-1 and 401B-1 include data stores 402A and 402B, respectively.

The terminal 406 includes a processing unit 406a, a display unit 406b and a storage unit 406c. The storage unit 406c includes a device management application 406c-1 which includes a core management unit 406c-1a.

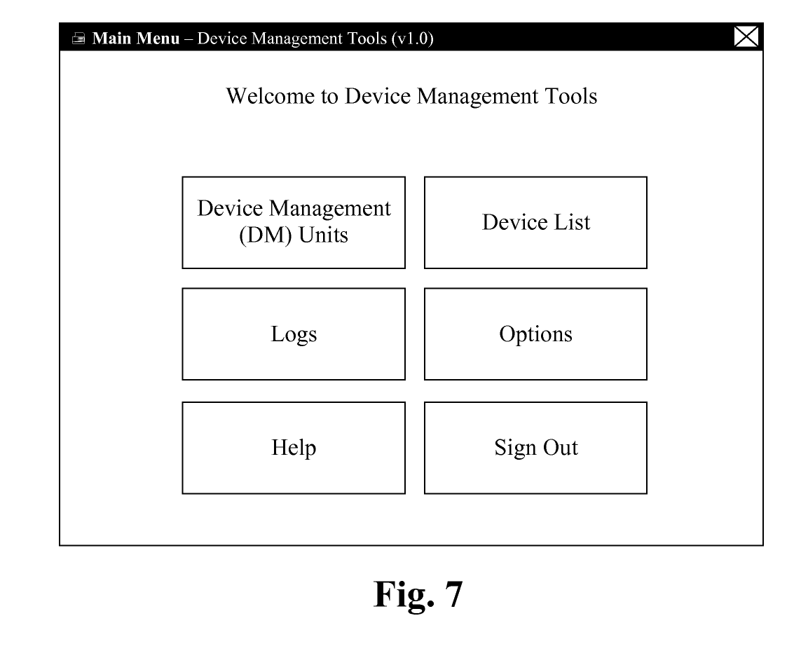

In the example of FIG. 4, the core management unit 406c-1a part of the device management application 406c-1 included within the storage unit 406c of the terminal 406. For example, when the processing unit 406a is caused to execute the device management application 406c-1, a user interface for utilizing the core management unit 406c-1a is displayed by the display unit 406b. Examples of such user interface are described infra with reference to FIGS. 7-9.

The core management unit 406c-1a communicates with a license management device 407,

Once a particular device management unit is installed in the system, an activation process to activate the particular device management unit is initiated. In such activation process, the core management unit communicates with the license management device 407 to register the particular device management unit in association with, for example, a network address of the core management apparatus, with the license management device 407.

For example, when a device management unit (e.g. a licensed software product) is installed on a new host computer, the software product may have to be activated online before the user (e.g. licensee) can utilize the features of the software product.

In the case of a volume license which allows installation and use of multiple copies of the software product (e.g. device management units), the core management unit 407c-1a keeps track of the number of licenses remaining. For example, if five device management unit licenses are initially obtained from the developer (e.g. person or company who developed the device management unit) by registering the licenses in association with the information (e.g. IP address, serial number and/or unit ID) of the core management unit 407c-1a, upon the installation of the first device management unit on a host computer, the core management unit 407c-1a automatically decrements the number of remaining licenses from five to four. Here, the user installing the first device management unit does not have to activate the device management unit again at least for the first five device management units, since they have already been registered with the license management device 407 in association with the information of the core management unit 406c-1a. Even when a device management unit is uninstalled and reinstalled on another host computer, there need not be deactivation of the device management unit and activation of the newly installed device management unit, as long as the number of installed device management units are within the number of available licenses (e.g. 5 in this case)

In the example above, if the first device management unit is uninstalled from the host computer, the core management unit 407c-1a automatically increments the number of remaining licenses from four to five.

In the example of FIG. 4, only two networks (Networks A and B) are shown in the interest of brevity, but the system 400 is not limited to such configuration. The core management unit 406c-1a may be configured to communicate with any arbitrary number of device management units 401A-1 and 401B-1 and other devices (e.g. license management device 407 and network devices 403).

Otherwise, operations of the elements of the system 400 are similar to those discussed in connection with the corresponding elements of the system 200 of FIG. 2A.

FIG. 6A shows an exemplary configuration of a computing device that can be configured (for example, through software) to operate (at least in part) as the core management unit and/or device management units of the present disclosure. As shown in FIG. 6A, the management unit 600 includes a controller (or central processing unit) 601 that communicates with a number of other components, including memory or storage part 602, network interface 603, display 604 and keyboard 605, by way of a system bus 609.

The management unit 600 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as will be appreciated to those skilled in the relevant arts.

In the management unit 600, the controller 601 executes program code instructions that controls device operations. The controller 601, memory/storage 602, network interface 603, display 604 and keyboard 605 are conventional, and therefore in order to avoid occluding the inventive aspects of this disclosure, such conventional aspects will not be discussed in detail herein.

The management unit 600 includes the network interface 603 for communications through a network, such as communications through the network 209 with the network-connected devices 201-203 in FIG. 2A. However, it should be appreciated that the subject matter of this disclosure is not limited to such configuration. For example, the management unit 600 may communicate with client terminals through direct connections and/or through a network to which some components are not connected. As another example, the management unit 600 does not need to be provided by a server that services terminals, but rather may communicate with the devices on a peer basis, or in another fashion.

The core management unit and/or the device management units of the present disclosure are not limited to a server or computer, but can be manifested in any of various devices that can be configured to communicate over a network and/or the Internet.

An example of a configuration of the terminal 207 of FIG. 2A and/or the terminal 406 of FIG. 4 (for example, as a computer) is shown schematically in FIG. 6B. In FIG. 6B, computer 650 includes a controller (or central processing unit) 652 that communicates with a number of other components, including memory 653, display 654, keyboard (and/or keypad) 657, other input/output (such as mouse, touchpad, stylus, microphone and/or speaker with voice/speech interface and/or recognition software, etc.) 658, network interface 659, print driver 656 and application software 655, by way of an internal bus 651.

The memory 653 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 659 provides a connection (for example, by way of an Ethernet connection or other network connection which supports any desired network protocol such as, but not limited to TCP/IP, IPX, IPX/SPX, or NetBEUI) to the network to which the computer 650 is connected (e.g. network 209 of FIG. 2A).

Print driver 656 and application software 655 are shown as components connected to the internal bus 651, but in practice are typically stored in storage media such as a hard disk or portable media, and/or received through the network, and loaded into memory 653 as the need arises.

Depending on the type of the particular terminal device, one or more of the components shown in FIG. 6B may be missing. For example, a particular mobile phone may be missing the print driver 656 and the keyboard 657.

Additional aspects or components of the computer 650 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

Each of the devices 201-203 of FIG. 2A may be any device including but not limited to a personal, notebook or workstation computer, a terminal, a kiosk, a personal digital assistant (PDA), a tablet computing device, a smartphone, a scanner, a printer, a facsimile machine, a multi-function device (MFD), a server, a mobile phone or handset, another information terminal, etc. Each network-connected device may be configured with software allowing the network-connected device to communicate through a network with a core management unit and/or device management units.

FIG. 6C shows a schematic diagram of a configuration of a network-connected device as an MFD, according to an exemplary embodiment, which can be any apparatus (including a microprocessor chip or a collection of devices having varying degree of integration) that has the ability to perform two or more functionalities.

The MFD 690 shown in FIG. 6C includes a controller 692, and various elements connected to the controller 692 by an internal bus 691. The controller 692 controls and monitors operations of the MFD 690. The elements connected to the controller 692 include storage 693 (for example, random access memory, read-only memory, hard disk drive, portable storage media drive such as for optical discs, magnetic discs, magneto-optical discs, etc., semiconductor memory cards, combinations of storage media, etc.), printer engine 694, scanner engine 695, network interface (I/F) 696, converter 698 for converting data from one format to another format (for example, a format suitable for printing, faxing, e-mailing, etc.), and user I/O (Input/Output) 699. The controller 692 also utilizes information stored in user management table 697 to authenticate the user and control user access to the functionalities of the MFD 690.

Storage 693 can include one or more storage parts or devices [e.g. a read only memory (for example, ROM, PROM, EPROM, EEPROM, etc.), a random access memory (RAM), a hard disk drive (HDD), portable media (for example, floppy disk, optical disc, magnetic discs, magneto-optical discs, semiconductor memory cards, etc.) drives], and program code instructions can be stored in one or more parts or devices of storage 693 and executed by the controller 692 to carry out the instructions. Such instructions can include instructions for performing specified functions (such as printing, scanning, faxing, copying, e-mailing, etc.) of the MFD 690, to enable the MFD 690 to interact with a terminal, as well as perhaps other external devices, through the network interface 696, and to control the converter 698, access data in the user management table 697, and interactions with users through the user I/O 699.

The network interface 696 is utilized by the MFD 690 to communicate with other network-connected devices such as a terminal or a device management unit (e.g., device management units 204A-1 and 204B-1 of FIG. 2A) and receive data requests, print jobs, user interfaces, and etc.

The user I/O 699 includes one or more display screens that display, under control of controller 692, information allowing the user of the MFD 690 to interact with the MFD 690. The display screen can be any of various conventional displays (such as a liquid crystal display, a plasma display device, a cathode ray tube display, etc.), but preferably is equipped with a touch sensitive display (for example, liquid crystal display) and is configured to provide a GUI (graphical user interface) based on information input by an operator of the MFD 690, so as to allow the operator to interact conveniently with services provided on the MFD 690, or with the MFD 690 serving as terminal for accessing electronic data or other content through the network. User interfaces or other contents received through the network via the network interface 696 can be displayed on the display screen.

The display screen does not need to be integral with, or embedded in, a housing of the MFD 690, but may simply be coupled to the MFD 690 by either a wire or a wireless connection. The user I/O 699 may include keys and/or buttons (such as graphical keys or buttons, or other graphical elements, of a GUI on a touchscreen display) for inputting information or requesting various operations. Alternatively, the user I/O 699 and the display screen may be operated by a keyboard, a mouse, a remote control, voice recognition (e.g., through a speaker/microphone 699a), or eye-movement tracking, or a combination thereof.

Printer engine 694, scanner engine 695 and network interface 696 are otherwise conventional, and therefore, a detailed description of such conventional aspects is omitted in the interest of clarity and brevity.

The MFD 690 can have any or all of the functions of similar devices conventionally known, such as for scanning, editing and storing images, sending a fax, sending and receiving e-mails with or without attachments, accessing files by FTP or another protocol or facility, surfing the Web, etc. Further, multi-functional devices or multi-function peripheral devices can play a prominent role to convert hardcopy documents to electronic documents.

The MFD 690 may also operate as a device management unit (e.g. device management units 204A-1 and 204B-1 of FIG. 2A), or as a core management unit (e.g. core management apparatus 206 of FIG. 2A). The operation of such device management unit or core management unit according to an exemplary embodiment is described supra with reference to FIG. 2A.

FIG. 7 shows a screenshot of a main menu in an application software product for providing device management services, according to an exemplary embodiment. Such main menu screen is displayed on the terminal device of the user when the user successfully signs in, for example, by providing login credentials. In the example of FIG. 7, the main menu screen has the following buttons: “device management (DM) units” for displaying the DM units currently registered in the system, “device list” for displaying the list of network devices in the network environment, “logs” for displaying a log file which records various events that occur in the network environment managed by the device management application, “options” for allowing the user to configure various settings that govern the operation of the device management application, and “sign out” for signing out of the device management application.

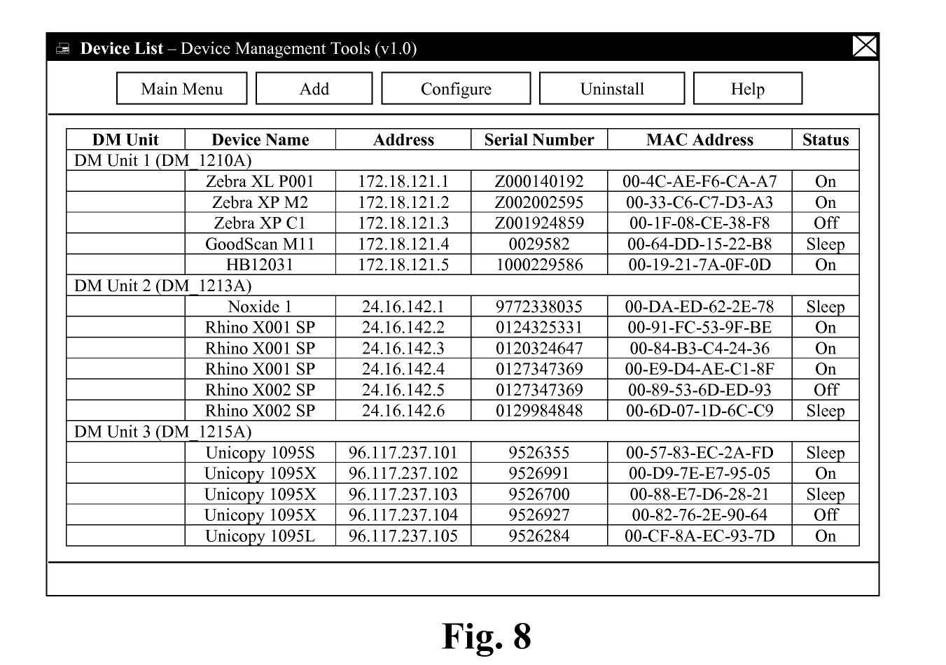

FIG. 8 shows a screenshot of a user interface (UI) displayed upon activating the “device list” button of FIG. 7, according to an exemplary embodiment. As shown in FIG. 8, a list of devices connected to the network (or networks accessible by the user) is displayed to the user. In the example of FIG. 8, the list is divided into three groups, each group of devices being managed by a different device management unit. That is, each of the device management units (e.g. DM Units 1-3) is responsible for managing a subset of the network devices in the network environment.

At the top of the screen, buttons are provided for returning to the main menu screen (“main menu”), installing a new network device or DM unit (“add”), configuring one or more existing devices or DM units (“configure”), uninstalling one or more existing devices or DM units (“uninstall”), and obtaining additional details regarding the device list (“help”).

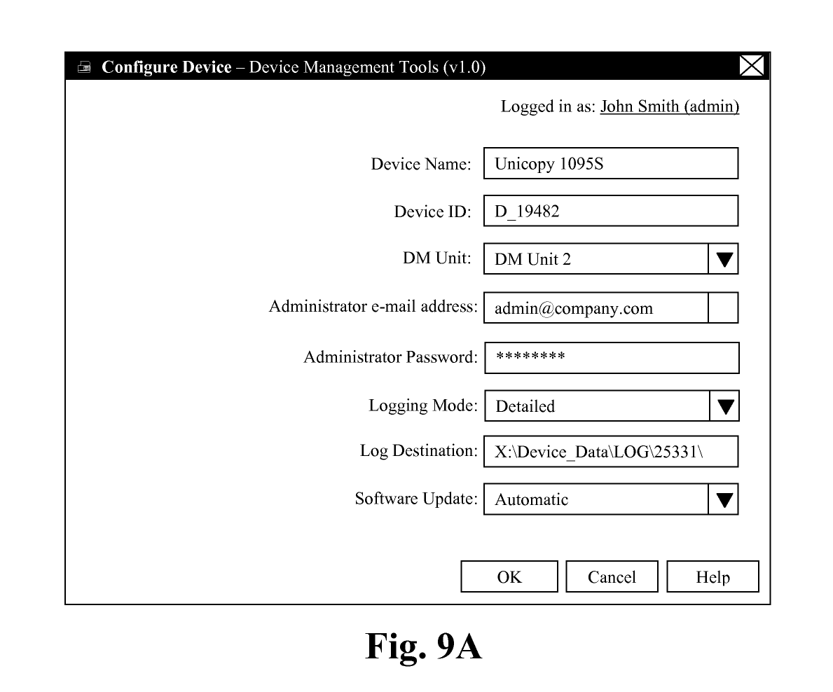

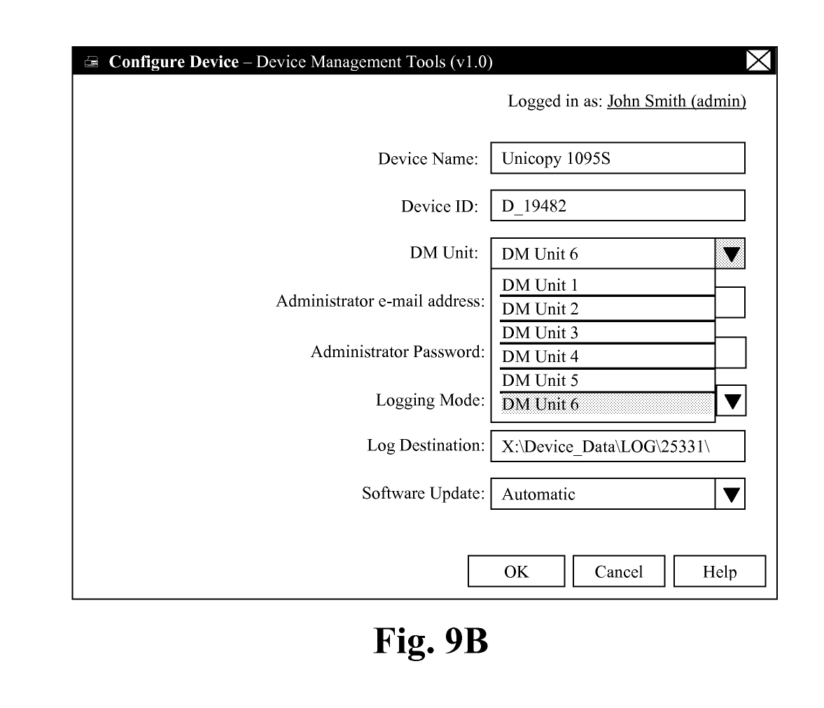

For example, when a device is selected from the device list and the “configure” button is activated, a user interface for device configuration is displayed to the user, as shown in FIG. 9A. The user interface allows the user to configure various settings and parameters of the selected device (e.g. device name, device ID, DM unit, administrator e-mail address, administrator password, logging mode, log destination, software update shown in FIG. 9A). The device settings configurable via the user interface are not limited to those shown in the example of FIG. 9A, and may include a wide range of other device settings, such as network settings, authentication settings, log settings, image settings, print settings and etc. In particular, the “DM Unit” parameter shown in FIG. 9A indicates which DM unit is responsible for managing the selected device. The user may specify a DM unit, for example, from the drop-down list shown in the example of FIG. 9B, and the selected device is assigned to the DM unit specified by the user.

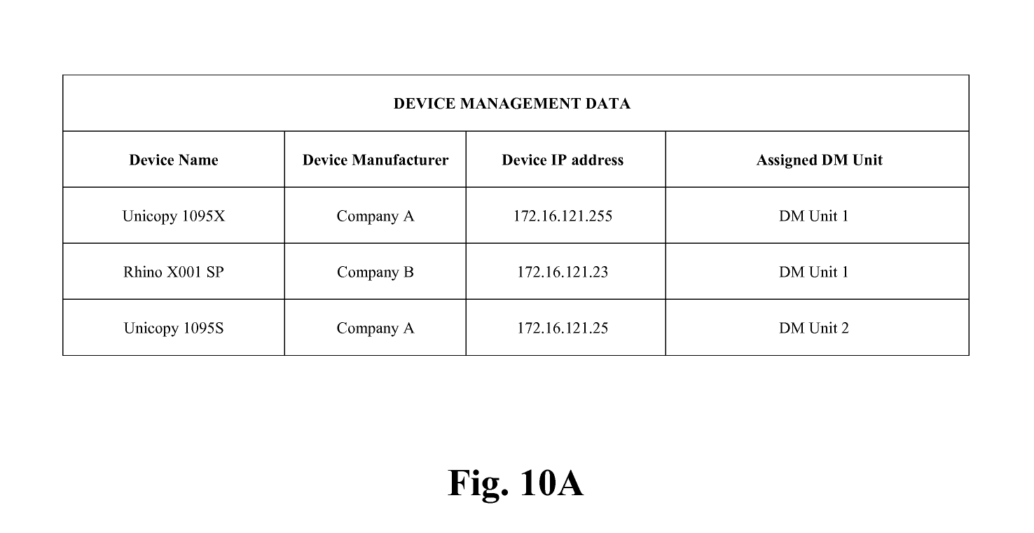

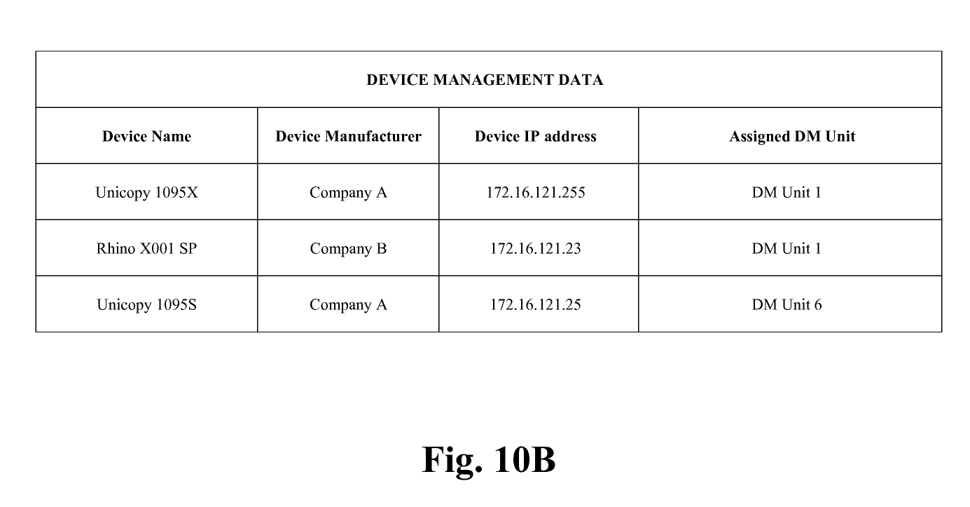

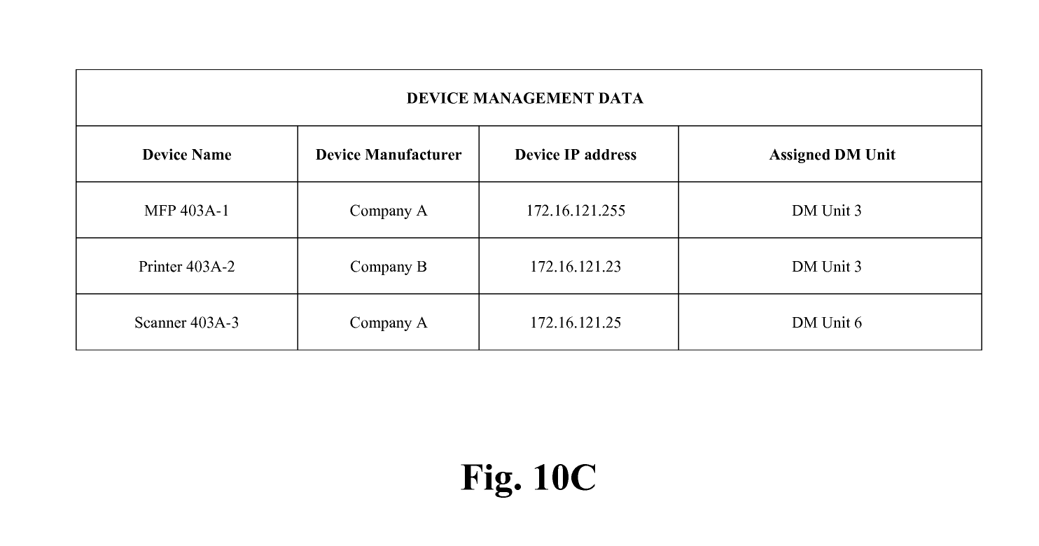

The information of the DM unit specified for the particular device is recorded, for example, as part of the device management data maintained by either the core management unit or the device management unit, as shown in FIG. 10A (e.g. under “Assigned DM Unit” column). Thus, devices can easily be moved across various DM units or servers using the user interface shown in FIGS. 9A and 9B.

For example, when the value of the “DM Unit” setting of a particular device (i.e. “Unicopy 1095S”) is changed from DM Unit 2 (FIG. 9A) to DM Unit 6 (FIG. 9B), the device management data corresponding to the particular device is updated, as shown in FIGS. 10A and 10B (i.e. the value of the “Assigned DM Unit” column is changed from DM Unit 2 to DM Unit 6).

Referring back to FIG. 8, device management units or devices managed by such device management units may be uninstalled by the user by activating the “uninstall” button. For example, when a device management unit is uninstalled, the entry corresponding to the uninstalled device management unit is deleted from the device management registry. As illustrated in FIGS. 5B and 5C, the entry corresponding to DM Unit 2 (which exists in the device management registry shown in FIG. 5B) is deleted and not shown in the device management registry in FIG. 5C. However, other data entries corresponding to the uninstalled DM unit, including the device information and setting information of the uninstalled DM unit, remain intact, as illustrated in FIGS. 5B and 5C. Such data entries are utilized in the case that the uninstalled DM unit is later reinstalled (e.g. to automatically configure the DM unit or supply data to the DM unit).

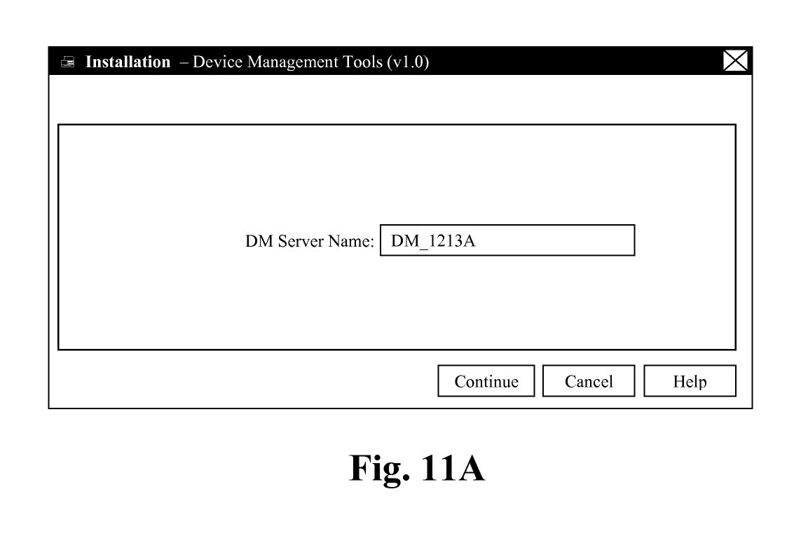

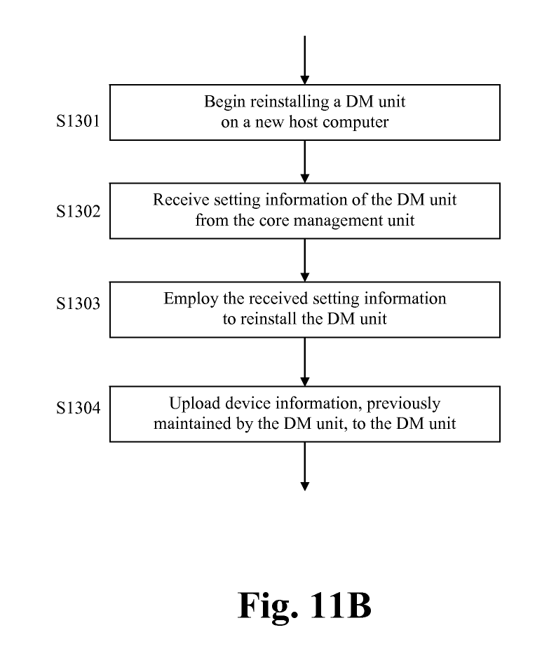

FIG. 11A shows a user interface displayed to the user during installation of a device management unit. In an exemplary embodiment, when a particular device management unit is installed in a system, the particular device management unit is assigned a management unit name which is stored in a registry of device management units, as shown in FIGS. 5B and 5C. During the installation of the device management unit, if the user specifies a DM unit name that already exists in the database but is not part of the device management registry (that is, the particular DM unit was previously installed and uninstalled from the system), the core management unit retrieves the setting information of the DM unit having the same DM unit name as the name provided by the user. In the example of FIG. 11A, the user has typed in the DM unit ID “DM_{—}1213A” which corresponds to DM Unit 2 in FIG. 5C (indeed, any identifier uniquely assigned to each of the DM units may be used, including the DM unit name, DM unit ID, etc.). Using the provided DM unit ID, the core management unit retrieves the entry corresponding to DM Unit 2 in the setting information table, and causes the DM unit to be installed and configured using the retrieved setting information. Similarly, once the DM unit is installed and configured, the DM unit is again registered in the device management registry, and the one or more entries (which represent device data previously collected by DM Unit 2 from the devices managed by DM Unit 2) corresponding to DM Unit 2 is retrieved from the device information table (e.g. FIG. 5C) and uploaded to the DM unit (an example of such reinstallation process is illustrated in FIG. 11B). Thus, the DM unit need not collect such device information again from the devices managed by the DM unit.

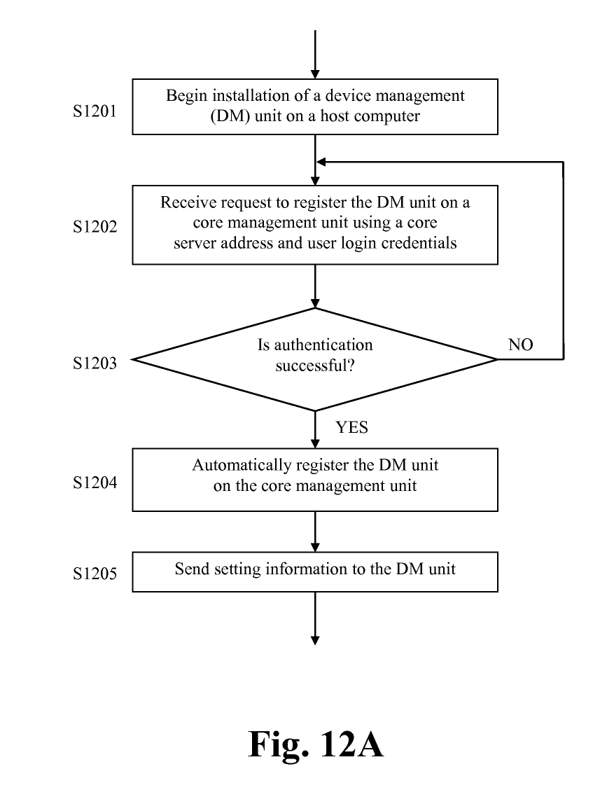

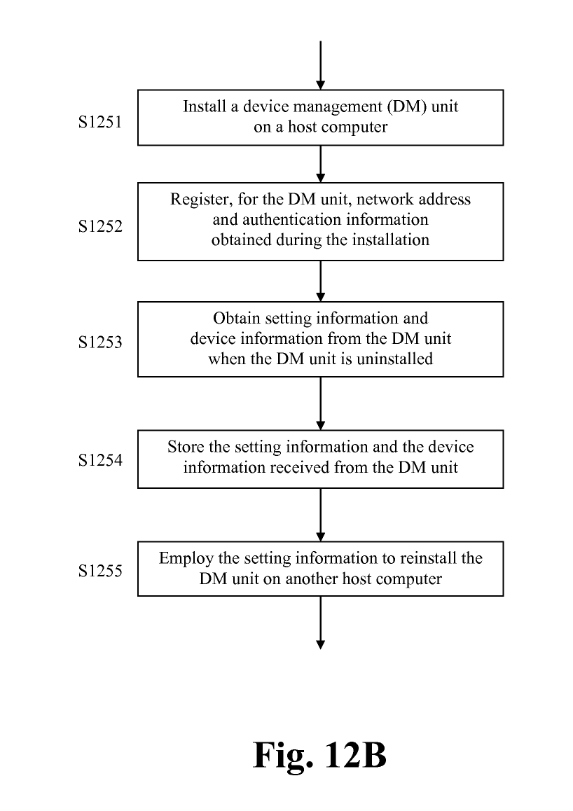

Turning now to FIG. 12A, there is shown a flow chart of a method of installing a DM unit, according to an exemplary embodiment.

When an installation process for installing a device management (DM) unit or server on a host computer is begun (step S1201), a core management unit is accessed using a core server address and user login credentials (step S1202).

In S1203, it is checked whether the core server address and the user login credentials are correct. For example, the core management unit at the provided core server address may access a database which contains login credentials of users who are authorized to access the core management unit and check whether the provided user login credentials exist in the database.

If the provided core server address and user login credentials are correct (YES, S1203), the DM unit is automatically registered on the core management unit (step S1204), and setting information is provided to the DM unit to automatically configure the DM unit to work properly. The setting information may be the setting information previously stored for the particular DM unit, or setting information newly created by the core management unit based on the DM unit (e.g. based on the type, model, make, etc. of the DM unit). For example, settings that would typically be specified by the user are retrieved from the core management unit (e.g. “department” shown in FIG. 5B, which may have be associated with a particular default configuration), and the DM unit is automatically configured to work properly with the core management unit.

On the other hand, if the core server address and the user login credentials are incorrect (NO, S1203), a new set of server address and login credentials are requested or the installation process is terminated.

Turning now to FIG. 12B, there is shown a flow chart of a method of reinstalling a DM unit, according to an exemplary embodiment.

In S1251 and S1252, a DM unit is installed on a host computer, and a network address and authentication information obtained during the installation process are registered for the DM unit (e.g. in the device management registry shown in FIG. 5B). When the DM unit is uninstalled, the setting information of the DM unit and the device information maintained by the DM unit are obtained from the DM unit (step S1253) and stored in a storage unit (step S1254). As discussed above, the storage unit may be internal or external to the core management apparatus, or accessible by the core management unit (and potentially by other devices) via the network. In S1255, the setting information is employed to reinstall the DM unit on another host computer.

Thus, by automatically obtaining the setting information and utilizing the obtained setting information to automatically complete the reinstallation process, the process of uninstalling the DM unit from a host computer and reinstalling on another host computer is simplified.

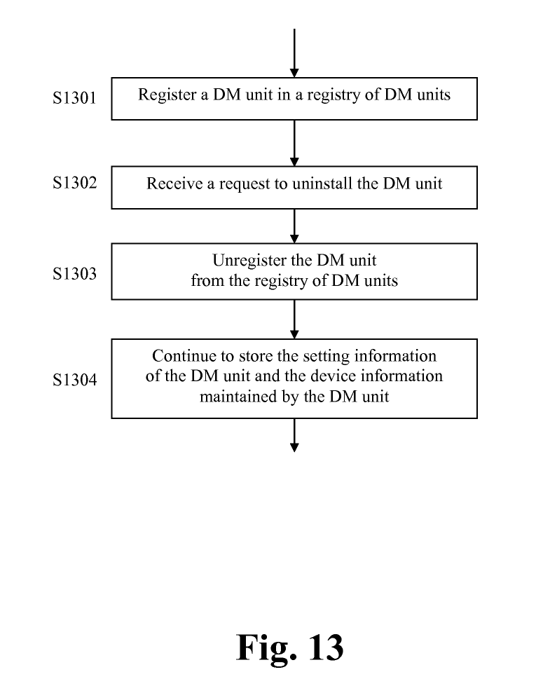

Turning now to FIG. 13, there is shown a flow chart of a method of uninstalling a DM unit, according to an exemplary embodiment.

When a request to uninstall a DM unit is received (step S1302) after the DM unit has been registered in the device management registry (e.g. FIG. 5B) (step S1301), the DM is unregistered (e.g. deleted) from the device management registry (step S1303). However, as discussed above, the setting information of the DM unit and the device information maintained by the DM unit continue to be stored by the core management unit for future use. For example, when the DM unit is reinstalled, the setting information stored by the core management unit may be utilized to automatically configure the DM unit to work properly with the core management unit, and the device information can automatically be uploaded to the DM unit.

By keeping the information corresponding to the uninstalled DM unit, the process of reconfiguring the DM unit when the DM unit is later reinstalled can be facilitated.

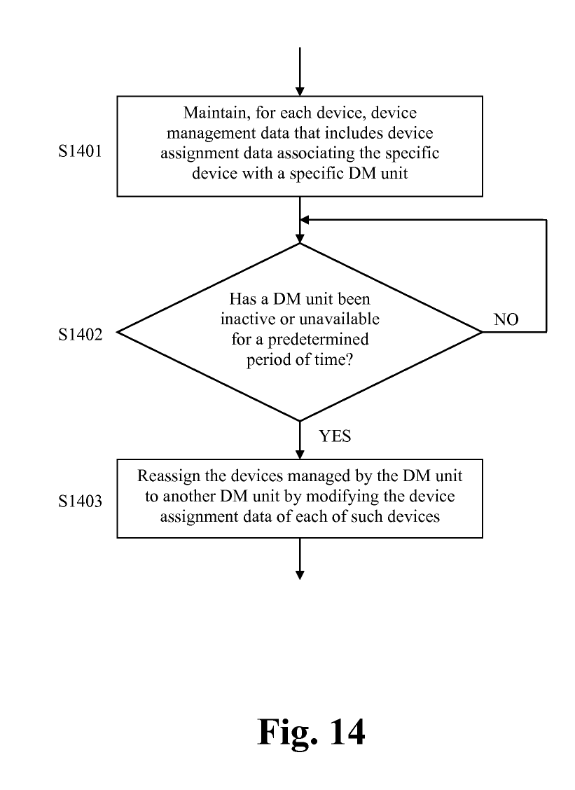

Turning now to FIG. 14, there is shown a flow chart of a method of reassigning devices to a DM unit, according to an exemplary embodiment.

As shown in FIG. 10A, for each device in the network environment, device management data is maintained which includes device assignment data associating each specific device with a corresponding DM unit responsible for managing the specific device (step S1401). In S1402, it is determined whether a DM unit has been inactive or unavailable for a predetermined period of time (e.g. one hour). If a DM unit has been inactive or unavailable for the predetermined period of time (YES, S1402), the devices managed by the DM unit are reassigned to another DM unit by modifying the device assignment data of each of such devices (step S1403).

When a DM unit is down for a long time, the user and the system cannot monitor or configure the devices managed by such DM unit. Thus, by monitoring whether a particular DM unit is inactive or unavailable, and by automatically reassigning the devices managed by such unavailable DM unit to another DM unit, adverse effects of a DM unit going down can be reduced.

For example, when the devices managed by such unavailable DM unit is automatically reassigned to another DM unit, the device management data corresponding to the devices are updated, as shown in FIGS. 10B and 10C. In FIG. 10C, the value of the “Assigned DM Unit” column for each of the devices managed by such unavailable DM unit (e.g. DM Unit 1) is changed from DM Unit 1 to DM Unit 3, which is active and functioning properly).

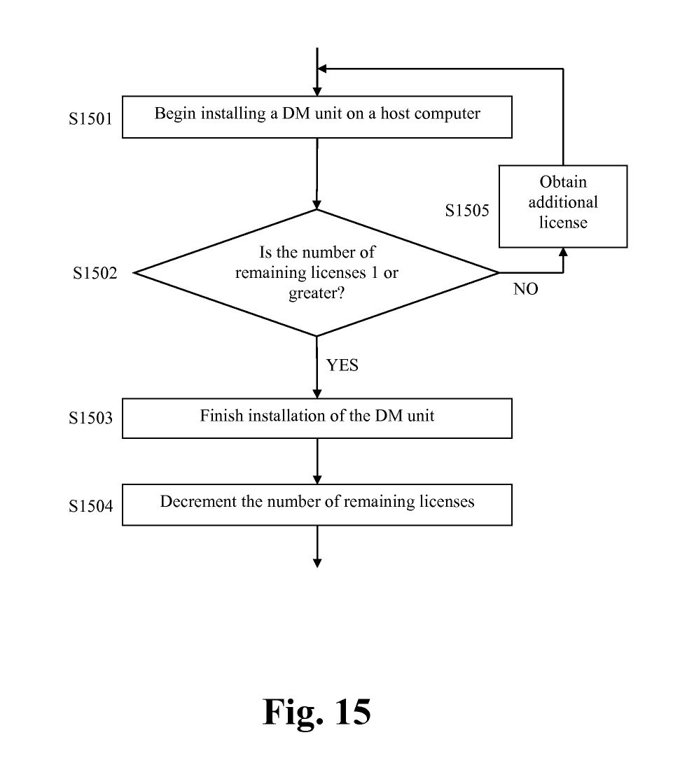

Turning now to FIG. 15, there is shown a flow chart of a method of activating a DM unit, according to an exemplary embodiment.

Upon installation of a DM unit on a host computer (step S1501), the core management unit determines whether the number of remaining licenses is greater than or equal to 1 (step S1502). If the number of remaining licenses is greater than or equal to 1 (YES, S1502), the installation of the DM unit is completed (step S1503), the number of remaining licenses is decremented by 1 (step S1504). In a similar manner, when a DM unit is uninstalled from the system, the remaining number of licenses is automatically incremented by 1. For example, although S1503 is performed before S1504 in this exemplary embodiment, the order in which the steps are performed may be switched in another exemplary embodiment.

In a case that the number of remaining licenses is less than 1 (i.e. zero) (NO, S1502), additional licenses are obtained (e.g. by communicating with the license management device, either automatically or with user approval) (step S1505), and the installation process is started over.

Thus, as long as the number of remaining licenses (which is maintained by the core management unit) is greater than or equal to 1, the user does not have to go through the activation process each time a DM unit is installed (e.g. all the available licenses have already been activated using the information of the core management unit). Thus, even if a DM is uninstalled from a host computer and reinstalled on a different host computer, the conventional deactivation and re-activation of the product are not needed.

In the aforementioned aspects of the present disclosure, even when the size of the network environment grows to include an overwhelming number of network-connected devices, thus necessitating multiple device management units, management of such device management units can be facilitated by providing convenient installation, uninstallation, reinstallation, activation and deactivation of the device management units and relocation (i.e. reassignment) of the devices managed by the device management units.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. A core management apparatus configured to manage one or more device management units that manage devices in a network system, wherein each device management unit is installed in an installation process on a corresponding host computer, and manages, and collects device data from, a corresponding plurality of network devices, said core management apparatus comprising:
a core management part that monitors the one or more device management units, and registers for each particular device management unit amongst the one or more device management units, a network address and authentication information, specific to the particular device management unit, and obtained in the installation process installing the particular device management unit in the system;
an information storing part that stores information captured from the particular device management unit; and
a network communication part that communicates with devices in the network system,
wherein when the particular device management unit is uninstalled from the corresponding host computer, setting information of the particular device management unit and device information maintained by the particular device management unit are obtained from the particular device management unit, received through the network communication part, and stored in the information storing part, and
said setting information stored by the information storing part is communicated through the network communication part and employed to reinstall the particular device management unit on another host computer, without having the user specify settings for reinstalling the particular device management unit on said another host computer.

2. The core management apparatus of claim 1, wherein
in a registration process registering the particular device management unit in the system, the core management part registers the particular device management unit in a device management registry, and
when the particular device management unit is uninstalled from the corresponding host computer, the core management part unregisters the particular device management unit from the registry of the device management units, but the information storing part continues to store the setting information of the particular device management unit and the device information that was captured from the particular device management unit.

3. The core management apparatus of claim 1, wherein when the particular device management unit is reinstalled on said another host computer, the core management part causes the device information, which was maintained by the particular device management unit and stored by the information storing part, to be uploaded to the particular device management unit reinstalled on said another host computer.

4. The core management apparatus of claim 1, wherein
the core management part maintains for each specific device amongst the network devices in the system, device management data that includes device assignment data associating the specific device with a specific device management unit assigned to manage the specific device, wherein
the core management part modifies the device assignment data of the specific device to reassign management of the specific device from the specific device management unit to another device management unit.

5. The core management apparatus of claim 1, wherein
the core management part maintains for each specific device amongst the network devices in the system, device management data that includes device assignment data associating the specific device with a specific device management unit assigned to manage the specific device,
said particular device management unit manages one or more particular devices amongst the network devices in the system, and
when the particular device management unit is inactive or unavailable for at least a predetermined period of time, the core management part automatically modifies the device management data of each particular device amongst the one or more particular devices to associate the particular device with another device management unit for managing said particular device.

6. The core management apparatus of claim 1, wherein
in an activation process to activate the particular device management unit after the particular device management unit is installed, the core management part communicates through the network communication part with a license management device external to the core management apparatus and registers the particular device management unit in association with a network address of the core management apparatus, with the license management device.

7. A system for managing devices in a network environment, said system comprising:
one or more device management units, wherein each device management unit amongst the one or more device management units is installed in an installation process on a corresponding host computer, and manages, and collects device data from, a corresponding plurality of network devices;
a core management unit that manages the one or more device management units in the system, wherein
the core management unit registers for each particular device management unit amongst the one or more device management units, a network address and authentication information, specific to the particular device management unit, and obtained in the installation process installing the particular device management unit in the system, and wherein
when the particular device management unit is uninstalled from the corresponding host computer, setting information of the particular device management unit and device information maintained by the particular device management unit are captured and stored by the core management unit, and
said setting information captured and stored by the core management unit are retrieved from the core management unit and employed to reinstall the particular device management unit on another host computer, without having the user specify settings for reinstalling the particular device management unit on said another host computer.

8. The system of claim 7, wherein
in a registration process registering the particular device management unit in the system, the core management unit registers the particular device management unit in a registry of the device management units, and
when the particular device management unit is uninstalled from the corresponding host computer, the particular device management unit is unregistered from the registry of the device management units, but the core management unit continues to store the setting information of the particular device management unit and the device information that was captured from the particular device management unit.

9. The system of claim 7, wherein
the particular device management unit is assigned a management unit name, and
in a registration process registering the particular device management unit in the system, the core management unit registers, in a registry of the device management units, (i) the management unit name of the particular device management unit and (ii) the network address and authentication information obtained in the installation process, in association with the particular device management unit in the system, and
when the particular device management unit is uninstalled from the corresponding host computer, the core management unit stores the setting information of the particular device management unit and the device information captured from the particular device management unit in association with the management unit name of the particular device management unit, and
when the particular device management unit is reinstalled on said another host computer, the core management unit registers the particular device management unit in the registry once again automatically using the same management unit name.

10. The system of claim 7, wherein when the particular device management unit is reinstalled on said another host computer, the device information that was maintained by the particular device management unit and captured and stored by the core management unit is uploaded to the particular device management unit reinstalled on said another host computer.

11. The system of claim 7, wherein
the core management unit maintains for each specific device amongst the network devices in the system, device management data that includes device assignment data associating the specific device with a specific device management unit assigned to manage the specific device, and
the core management unit modifies the device assignment data of the specific device to reassign management of the specific device from the specific device management unit to another device management unit.

12. The system of claim 7, wherein
the core management unit maintains for each specific device amongst the network devices in the system, device management data that includes device assignment data associating the specific device with a specific device management unit assigned to manage the specific device, and wherein
said particular device management unit manages one or more particular devices amongst the network devices in the system, and
when the particular device management unit is inactive or unavailable for at least a predetermined period of time, the core management unit automatically modifies the device management data of each particular device amongst the one or more particular devices to associate the particular device with another device management unit for managing said particular device.

13. The system of claim 7, wherein
in an activation process to activate the particular device management unit after the particular device management unit is installed, the core management unit communicates through a network with a license management device and registers the particular device management unit in association with a network address of the core management unit, with the license management device.

14. A method of managing one or more device management units that manage devices in a network system, including managing and collecting device data from a corresponding plurality of network devices, said method comprising:
installing each management unit on a corresponding host computer in an installation process, and registering for each particular device management unit amongst the one or more device management units, a network address and authentication information, specific to the particular device management unit and obtained in the installation process;
monitoring the one or more device management units;
obtaining, when the particular device management unit is uninstalled from the corresponding host computer, setting information of the particular device management unit and device information maintained by the particular device management unit, from the particular device management unit;
storing the setting information and the device information received from the particular device management unit; and
employing the setting information to reinstall the particular device management unit on another host computer, without having a user specify settings for reinstalling the particular device management unit on said another host computer.

15. The method of claim 14, further comprising:
registering, in a registration process registering the particular device management unit in the network system, the particular device management unit in a registry of the device management units; and
unregistering, when the particular device management unit is uninstalled from the corresponding host computer, the particular device management unit from the registry of the device management units, but continuing to store the setting information of the particular device management unit and the device information that was captured from the particular device management unit.

16. The method of claim 14, further comprising:
assigning the particular device management unit a management unit name;
registering, in a registration process registering the particular device management unit in the network system, (i) the management unit name of the particular device management unit and (ii) the network address and authentication information obtained in the installation process, in a registry of the device management units, in association with the particular device management unit in the network system;
storing, when the particular device management unit is uninstalled from the corresponding host computer, the setting information of the particular device management unit and the device information captured from the particular device management unit in association with the management unit name of the particular device management unit; and
registering, when the particular device management unit is reinstalled on said another host computer, the particular device management unit in the registry once again automatically using the same management unit name.

17. The method of claim 14, further comprising:
uploading, when the particular device management unit is reinstalled on said another host computer, the stored device information to the particular device management unit reinstalled on said another host computer.

18. The method of claim 14, further comprising:
maintaining, for each specific device amongst the network devices in the system, device management data that includes device assignment data associating the specific device with a specific device management unit assigned to manage the specific device; and
modifying the device assignment data of the specific device to reassign management of the specific device from the specific device management unit to another device management unit.

19. The method of claim 14, further comprising:
maintaining, for each specific device amongst the network devices in the system, device management data that includes device assignment data associating the specific device with a specific device management unit assigned to manage the specific device; and
managing, by said particular device management unit, one or more particular devices amongst the network devices in the system; and
modifying, when the particular device management unit is inactive or unavailable for at least a predetermined period of time, the device management data of each particular device amongst the one or more particular devices automatically, to associate the particular device with another device management unit for managing said particular device.

20. The method of claim 14, further comprising:
communicating through a network with a license management device, in an activation process to activate the particular device management unit after the particular device management unit is installed, and registering the particular device management unit in association with a network address of the core management unit, with the license management device.
